(19) United States
(12) Patent Application Publication
(10) Pub. No.: US 2010/0014190 A1
(43) Pub. Date: Jan. 21, 2010

(54) RECORDING MEDIUM DRIVE

(75) Inventors: Toru Kohei, Kawasaki (JP); Kei Funabashi, Shanghai (CN)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/568,447

(22) Filed: Sep. 28, 2009

Related U.S. Application Data
(63) Continuation of application No. PCT/JP2007/059257, filed on Apr. 27, 2007.

(51) Int. Cl. G11B 17/02

(52) U.S. Cl. 360/99.08; G9B/17.002

(57) ABSTRACT

According to one embodiment, a recording medium drive includes a stator, a rotor, recording disks, an annular spacer, and an annular thin plate. The rotor is rotatably supported by the stator. The recording disks are mounted on the rotor. The annular spacer is mounted on the rotor between the recording disks. The annular thin plate is mounted on the rotor between one of the recording disks and the annular spacer. The thin plate includes a first thin plate, a second thin plate, and a viscoelastic body. The first and second thin plates are formed of a hard resin plate or a metal plate. The first thin plate is adjacent to either the one of the recording disks or the annular spacer, and the second thin plate is adjacent to the other. The viscoelastic body is interposed between the first thin plate and the second thin plate.

### CROSS-REFERENCE TO RELATED APPLICATIONS

This application is a continuation of PCT international application Ser. No. PCT/JP2007/059257 filed on Apr. 27, 2007 which designates the United States, the entire contents of which are incorporated herein by reference.

### BACKGROUND

1. Field

One embodiment of the invention relates to a thin plate that can be used for a recording medium drive.

2. Description of the Related Art

For example, a spindle motor is housed in the housing of a hard disk drive (HDD). A plurality of magnetic disks are fitted in the spindle motor. An annular spacer is interposed between the magnetic disks. A predetermined interval is formed between the magnetic disks. As disclosed in, for example, Japanese Patent Application Publication (KOKAI) No. 11-238333, a polymer elastic body is interposed between the magnetic disk and the annular spacer. The vibration of the magnetic disk can be prevented by the action of the polymer elastic body. Reference may also be had to Japanese Patent Application National Publication (Laid-Open) No. 2002-520544, and U.S. Pat. Nos. 6,064,547, 6,888,698, 4,945,432, 5,663,851, and 6,285,525.

The polymer elastic body is generally adhesive. Accordingly, when, for example, the magnetic disk is replaced, the annular spacer adheres to the magnetic disk by the polymer elastic body. This makes replacement work troublesome. When the polymer elastic body is replaced, the annular spacer also needs to be disposed of together with the polymer elastic body due to the adhesiveness. Because of the high cost of the annular spacer formed at high shape accuracy, this significantly increases the replacing cost.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view of the internal configuration of a hard disk drive (HDD) as a specific example of a recording medium drive according to an embodiment of the invention;

FIG. 2 is an exemplary cross-sectional view taken along line 2-2 of FIG. 1;

FIG. 3 is an exemplary exploded perspective view of a spindle motor in the embodiment;

FIG. 4 is an exemplary partially enlarged sectional view of a configuration of a thin plate in the embodiment;

FIG. 5 is an exemplary graph of the frequency characteristic of vibration in the embodiment;

FIG. 6 is an exemplary graph of the relation between the relative error of a recording disk and a carriage arm and the positioning accuracy of a head slider in the embodiment;

FIG. 7 is an exemplary exploded perspective view of the spindle motor in the embodiment;

FIG. 8 is an exemplary exploded perspective view of the spindle motor in the embodiment;

FIG. 9 is an exemplary exploded perspective view of the spindle motor in the embodiment;

FIG. 10 is an exemplary partially enlarged sectional view of a configuration of a thin plate according to another embodiment of the invention; and

FIG. 11 is an exemplary partially enlarged sectional view of a configuration of a thin plate according to a modification of the embodiment.

### DETAILED DESCRIPTION

Various embodiments according to the invention will be described hereinafter with reference to the accompanying drawings. In general, according to one embodiment of the invention, a recording medium drive comprises a stator, a rotor, recording disks, an annular spacer, and an annular thin plate. The rotor is rotatably supported by the stator. The rotor is configured to be rotatably supported by the stator. The recording disks are configured to be mounted on the rotor. The annular spacer is configured to be mounted on the rotor between the recording disks. The annular thin plate is configured to be mounted on the rotor between one of the recording disks and the annular spacer. The thin plate comprises a first thin plate, a second thin plate, and a viscoelastic body. The first thin plate is formed of a hard resin plate or a metal plate. The second thin plate is formed of a hard resin plate or a metal plate. The first thin plate is configured to be adjacent to either the one of the recording disks or the annular spacer, and the second thin plate is configured to be adjacent to either the annular spacer or the one of recording disks, respectively. The viscoelastic body is configured to be interposed between the first thin plate and the second thin plate.

According to another embodiment of the invention, a thin plate for a recording medium drive comprises a first annular thin plate, a second annular thin plate, and a viscoelastic body. The second annular thin plate has a surface facing a surface of the first thin plate. The first thin plate and the second thin plate are formed of the same material. The viscoelastic body is configured to be interposed between the surface of the first thin plate and the surface of the second thin plate.

According to still another embodiment of the invention, a recording medium drive comprises a stator, a rotor, a recording disk, a flange, a clamp, and an annular thin plate. The rotor is configured to be rotatably supported by the stator. The recording disk is configured to be mounted on the rotor. The flange is configured to be defined by the rotor. The clamp is configured to sandwich the recording disk with the flange. The annular thin plate is configured to be mounted on the rotor between the recording disk and the flange. The thin plate comprises a first thin plate, a second thin plate, and a viscoelastic body. The first thin plate is configured to be adjacent to the magnetic disk. The second thin plate is configured to be adjacent to the flange. The first thin plate and the second thin plate are formed of the same material. The viscoelastic body is configured to be interposed between the first thin plate and the second thin plate.

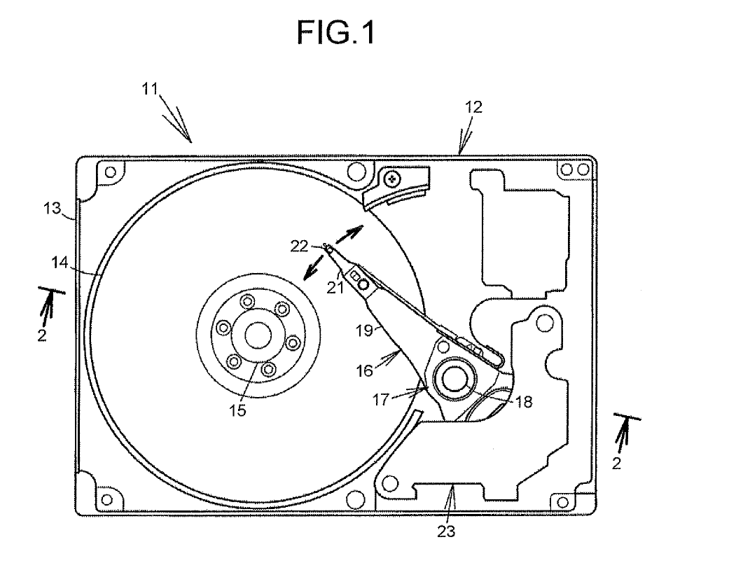

FIG. 1 schematically illustrates an internal configuration of a hard disk drive (HDD) 11 as an example of a recording medium drive according to an embodiment of the invention. The HDD 11 comprises a housing 12. The housing 12 has a box-shaped base 13 and a cover (not illustrated). The base 13 defines a flat rectangular parallelepiped internal space, i.e., a housing space. The base 13 may be molded by casting from a metal material such as aluminum. The cover is coupled to the opening of the base 13. The housing space is sealed between the cover and the base 13. The cover may be molded of one plate material by press working.

One or more magnetic disks 14 as recording media are housed in the housing space. It is assumed herein that, for example, four magnetic disks are housed. Each of the magnetic disks 14 has a diameter of, for example, 2.5 inches. The magnetic disk 14 is mounted on a spindle motor 15. The spindle motor 15 can rotate the magnetic disk 14 at high speed, such as 3600 rpm, 4200 rpm, 5400 rpm, 7200 rpm, 10000 rpm, and 15000 rpm.

A carriage 16 is also housed in the housing space. The carriage 16 comprises a carriage block 17. The carriage block 17 is rotatably coupled to a support shaft 18 extending in the vertical direction. A plurality of carriage arms 19 extending from the support shaft 18 in the horizontal direction are defined in the carriage block 17. The carriage block 17 may be molded of aluminum by extrusion.

A head suspension 21 is attached to the end of each of the carriage arms 19. The head suspension 21 extends forward from the end of the carriage arm 19. A flexure is attached to the front end of the head suspension 21. A flying head slider 22 is supported on the flexure. The flying head slider 22 can change its posture with respect to the head suspension 21 by the flexure. A magnetic head, i.e., an electromagnetic transducer device, is mounted on the flying head slider 22.

When an air flow is generated on a surface of the magnetic disk 14 by the rotation of the magnetic disk 14, positive pressure, i.e., buoyancy, and negative pressure act on the flying head slider 22 by the action of the air flow. When the buoyancy, the negative pressure, and a pressing force of the head suspension 21 are in balance, the flying head slider 22 can keep floating at relatively high rigidity during the rotation of the magnetic disk 14.

If the carriage 16 rotates about the support shaft 18 while the flying head slider 22 is floating, the flying head slider 22 can move along a radius line of the magnetic disk 14. As a result, the electromagnetic transducer device on the flying head slider 22 can traverse a data zone between the innermost recording track and the outermost recording track. Thus, the electromagnetic transducer device on the flying head slider 22 is positioned on the target recording track.

The carriage block 17 is connected to a power source such as a voice coil motor (VCM) 23. The carriage block 17 can rotate about the support shaft 18 by the action of the VCM 23. The swinging of the carriage arm 19 and the head suspension 21 can be realized by the rotation of the carriage block 17.

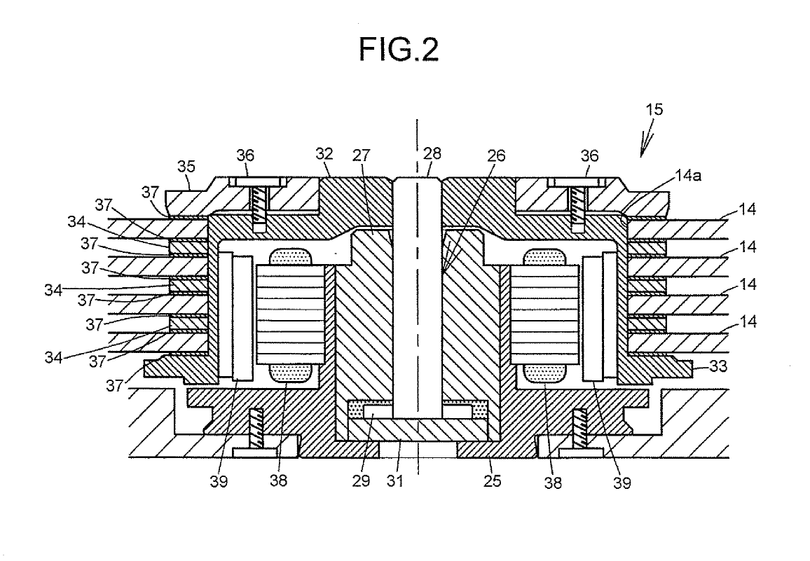

As illustrated in FIG. 2, the spindle motor 15 has a bracket 25 fixed to the bottom plate of the base 13. A fluid bearing 26 is incorporated into the bracket 25. A shaft 28 is received in the cylindrical space of a sleeve 27 of the fluid bearing 26. The bracket 25 and the sleeve 27 constitute the stator of the spindle motor 15.

A space between the sleeve 27 and the shaft 28 is filled with fluid such as lubricating oil. The shaft 28 can rotate at high speed about its axis in the sleeve 27 by the action of the fluid. A thrust flange 29 extending from the axis of the shaft 28 in the centrifugal direction is attached to the lower end of the shaft 28. The thrust flange 29 is received by a thrust plate 31. A space between the thrust flange 29 and the thrust plate 31 is also filled with fluid.

A rotor, i.e., a spindle hub 32, is fitted to the shaft 28. A flange 33 protruding to the outside is defined at the lower end of the spindle hub 32. The four magnetic disks 14 are mounted on the spindle hub 32. A through hole 14a penetrates through the center of each of the magnetic disks 14. The spindle hub 32 enters the through hole 14a. The lowermost magnetic disk 14 is received by the flange 33. An annular spacer 34 is interposed between the magnetic disks 14. The annular spacer 34 maintains the interval between the magnetic disks 14.

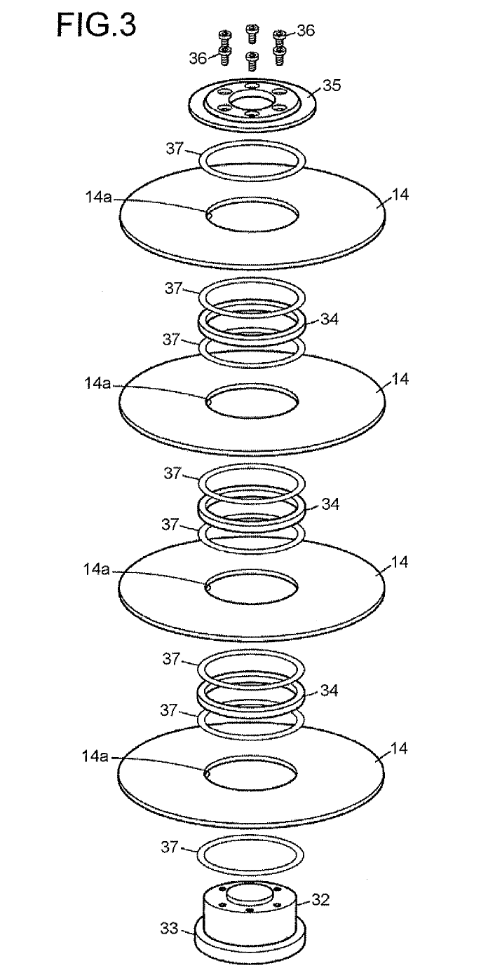

A clamp 35 is fitted to the upper end of the spindle hub 32. The clamp 35 is fixed onto the spindle hub 32 by six screws 36. With reference to FIG. 3, an annular thin plate 37 is arranged on the face or back sides of each of the magnetic disks 14. The thin plate 37 is arranged between the clamp 35 and the uppermost magnetic disk 14, between the lowermost magnetic disk 14 and the flange 33, or between the magnetic disk 14 and the annular spacer 34. The magnetic disks 14, the annular spacers 34, and the thin plates 37 are interposed between the clamp 35 and the flange 33.

A plurality of coils 38 are fixed about the shaft 28 onto the bracket 25. A plurality of permanent magnets 39 are fixed onto the spindle hub 32. Each of the permanent magnets 39 is arranged on the wall surface opposite the coil 38 in the spindle hub 32. When an electric current is supplied to the coil 38, a magnetic field is generated by the coil 38. The permanent magnet 39 is driven by the magnetic field of the coil 38. The rotation of the spindle hub 32 is caused at the axis of the shaft 28. The magnetic disk 14 is rotated.

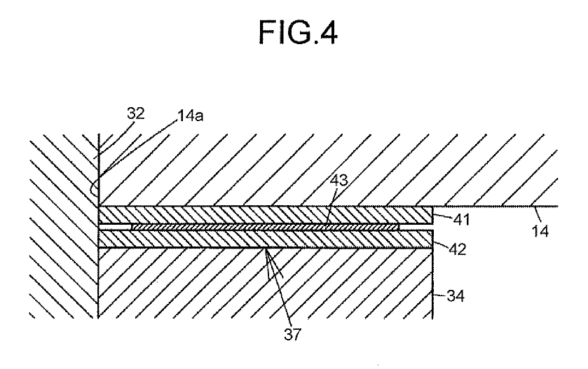

FIG. 4 schematically illustrates a configuration of the thin plate 37 of the embodiment. The thin plate 37 is interposed between the magnetic disk 14 and the annular spacer 34. The thin plate 37 has a first annular thin plate 41 adjacent to the back of the magnetic disk 14. The back of the first thin plate 41 faces the surface of a second annular thin plate 42. The back of the second thin plate 42 is adjacent to the surface of the annular spacer 34. The first thin plate 41 and the second thin plate 42 are formed of the same material. A hard resin plate such as a polyethylene terephthalate resin plate may be used for the first thin plate 41 and the second thin plate 42. The first thin plate 41 and the second thin plate 42 have the same outline. The width of the first thin plate 41 and the second thin plate 42 defined in the radius direction of the magnetic disk 14 is set to about 2 to 3 mm. A metal plate such as a stainless steel plate may be used for the first thin plate 41 and the second thin plate 42.

An annular viscoelastic body 43 is interposed between the first thin plate 41 and the second thin plate 42. A double-faced tape of a viscoelastic material such as VEM may be used for the viscoelastic body 43. The first thin plate 41 is bonded onto the second thin plate 42 by the action of the adhesive layer of the double-faced tape. The first thin plate 41 and the second thin plate 42 extend more largely than the viscoelastic body 43 in the radius direction of the magnetic disk 14. The inner edge of the viscoelastic body 43 is arranged outside from the inner edge of the first thin plate 41 and the inner edge of the second thin plate 42 in the radius direction of the magnetic disk 14. The outer edge of the viscoelastic body 43 is arranged inside from the outer edge of the first thin plate 41 and the outer edge of the second thin plate 42 in the radius direction of the magnetic disk 14. The protrusion of the viscoelastic body 43 from the outline of the thin plate 37 can be avoided irrespective of the sag of the viscoelastic body 43. The adhesion of the viscoelastic body 43 to the spindle hub 32 at the inner edge of the thin plate 37 can be avoided.

The first thin plate 41 and the second thin plate 42 may have the same thickness. The first thin plate 41 and the second thin plate 42 have a thickness of about 50 μm. The thickness of the viscoelastic body 43 is set to smaller than that of the first thin plate 41 and the second thin plate 42. The viscoelastic body 43 may have a thickness of about 25 μm. The thickness of the viscoelastic body 43 may be set to less than half of that of the first thin plate 41. The first thin plate 41 and the second thin plate 42 may have a thickness of about 100 μm. The thickness of the viscoelastic body 43 may be set to about 25 μm. The thickness of the viscoelastic body 43 may be set to less than a quarter of that of the first thin plate 41.

The first thin plate 41 is adjacent to the back of the clamp 35 between the uppermost magnetic disk 14 and the clamp 35. The second thin plate 42 is adjacent to the surface of the uppermost magnetic disk 14. The first thin plate 41 is adjacent to the back of the magnetic disk 14 between the lowermost magnetic disk 14 and the flange 33. The second thin plate 42 is adjacent to the surface of the flange 33. The first thin plate 41 is adjacent to the back of the annular spacer 34 between the annular spacer 34 and the magnetic disk 14. The second thin plate 42 is adjacent to the surface of the magnetic disk 14.

In the HDD 11, the thin plate 37 is interposed between the magnetic disk 14 and the annular spacer 34, between the magnetic disk 14 and the clamp 35, or between the magnetic disk 14 and the flange 33. The viscoelastic body 43 of the thin plate 37 is deformed by the vibration of the magnetic disk 14. The vibration of the magnetic disk 14 is attenuated by the deformation of the viscoelastic body 43. The positioning accuracy of the flying head slider 22 can be improved. Magnetic information can be written into the precise recording track position on the magnetic disk 14.

The first thin plate 41 and the second thin plate 42 of the thin plate 37 are adjacent to the magnetic disk 14, the annular spacer 34, the clamp 35, or the flange 33. The adhesion of the viscoelastic body 43 to the magnetic disk 14, the annular spacer 34, the clamp 35, and the flange 33 can be avoided. When the magnetic disk 14 is replaced, the magnetic disk 14, the annular spacer 34, and the thin plate 37 can be removed alone. The replacing operation can be simplified. The disposal of the expensive annular spacer 34 formed at a high shape accuracy can be avoided. The annular spacer 34 can be reused.

The clamp 35 exerts a pressing force toward the flange 33 by the torque of the screws 36. The sag is caused in the viscoelastic body 43 by the pressing force. The thickness of the viscoelastic body 43 is reduced to the lowest possible thickness by the first thin plate 41 and the second thin plate 42 of the thin plate 37. Typically, as the thickness of the viscoelastic body 43 is increased, the sag of the viscoelastic body 43 is increased. If the thickness of the viscoelastic body 43 is smaller than ever, the sag can be reduced. An error of the height of the carriage arm 19 from the surface of the magnetic disk 14 can be reduced.

The inventors examined the effect of the thin plate 37. For the examination, the inventors prepared the HDD 11 according to a specific example of the embodiment and an HDD as a comparative example. In the comparative example, the incorporation of the thin plate 37 was omitted. In the specific example and the comparative example, the number of revolutions of the magnetic disk was set to 10000 rpm. A magnetic disk having a diameter of 2.5 inches was used. Magnetic information was read from the magnetic disk by the electromagnetic transducer device of the flying head slider. The frequency characteristic of vibration was analyzed by the magnetic information.

As illustrated in FIG. 5, the frequency gain of the specific example was lower than that of the comparative example. In particular, the gain reduced in the frequency range of 2000 to 3000 Hz. Such frequency is recognized as the vibration of the magnetic disk. Thus, it was found that in the HDD 11 of the specific example, the vibration of the magnetic disk 14 was reduced by the action of the thin plate 37. It was also found that the relative displacement between the flying head slider 22 and the magnetic disk 14 was prevented. In the specific example, the gain reduced outside the range of 2000 to 3000 Hz.

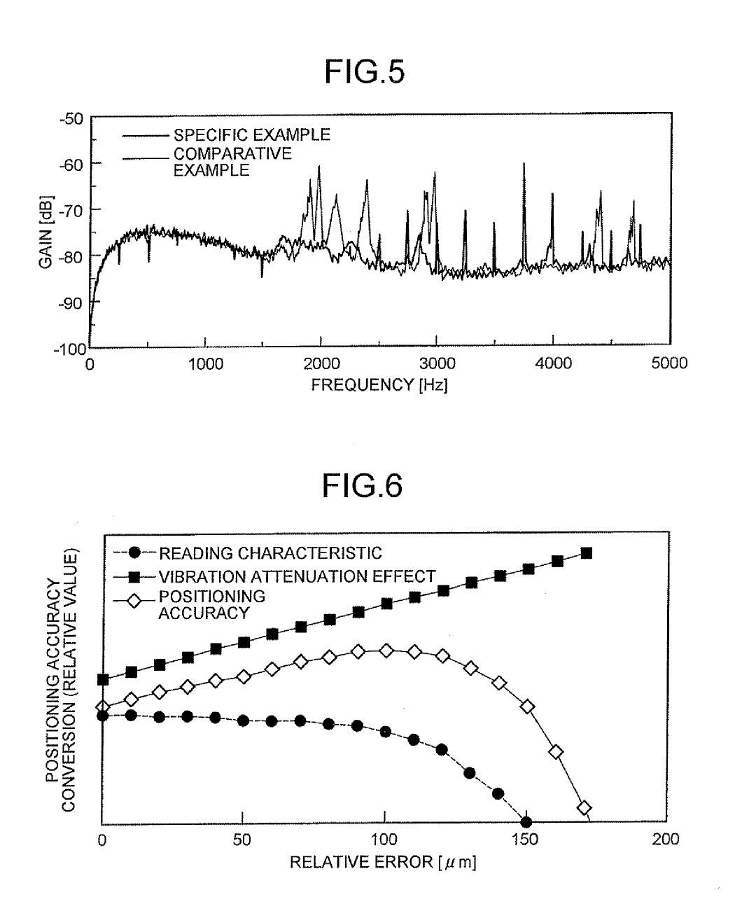

FIG. 6 is a graph of the relation between the relative error of the height of the carriage arm 19 from the surface of the magnetic disk 14 and the positioning accuracy of the flying head slider 22. The positioning accuracy conversion on the vertical axis corresponds to the positioning accuracy. As the relative error increases from 100 μm, the reading characteristic of the magnetic information deteriorates. As the relative error increases, the vibration attenuation effect of the viscoelastic body 43 increases. Typically, as the thickness of the viscoelastic body 43 increases, the vibration attenuation effect increases. The positioning accuracy corresponds to the addition result of the reading characteristic and the vibration attenuation effect. Thus, it was found that, when the relative error is set to, for example, 100 μm or less, the positioning accuracy can be satisfactorily maintained.

In the HDD 11, the eight thin plates 37 are mounted on the spindle motor 15. If the allowance value of the relative error of the magnetic disk 14 and the carriage arm 19 is set to, for example, 100 μm, then, the equation: 100 μm=X (the thickness of the viscoelastic body 43)×8 (thin plates)×0.2 (sag)+50 μm (the accuracy error of other components) is established. Typically, the sag of the viscoelastic body 43 corresponds to 20% of the thickness of the viscoelastic body 43. By this equation, the thickness X of the viscoelastic body 43 may be set to 31.25 μm or less. If the thin plate 37 having the viscoelastic body 43 having such thickness is used, the relative error can be set to less than the allowance value irrespective of the sag of the viscoelastic body 43. The positioning accuracy of the flying head slider 22 can be satisfactorily maintained.

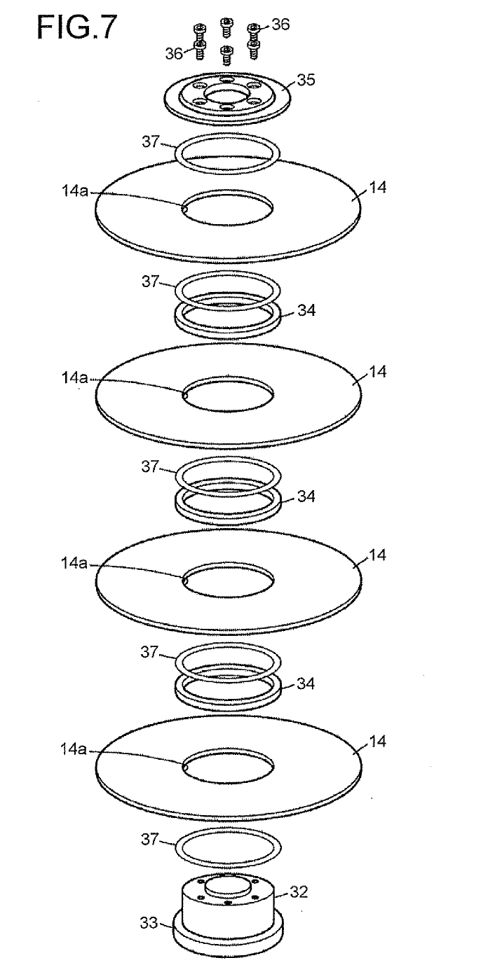

As illustrated in FIG. 7, the thin plate 37 may be arranged only on the back of the magnetic disk 14. The thin plate 37 may be interposed between the uppermost magnetic disk 14 and the clamp 35. The same configurations and structures as FIG. 3 are indicated by similar reference numerals. The spindle motor 15 can realize the same operation effect as FIG. 3. The number of the thin plates 37 is smaller than FIG. 3. The total thickness of the viscoelastic body 43 is reduced. The sag of the viscoelastic body 43 can be prevented. The relative error of the magnetic disk 14 and the carriage arm 19 can be reduced.

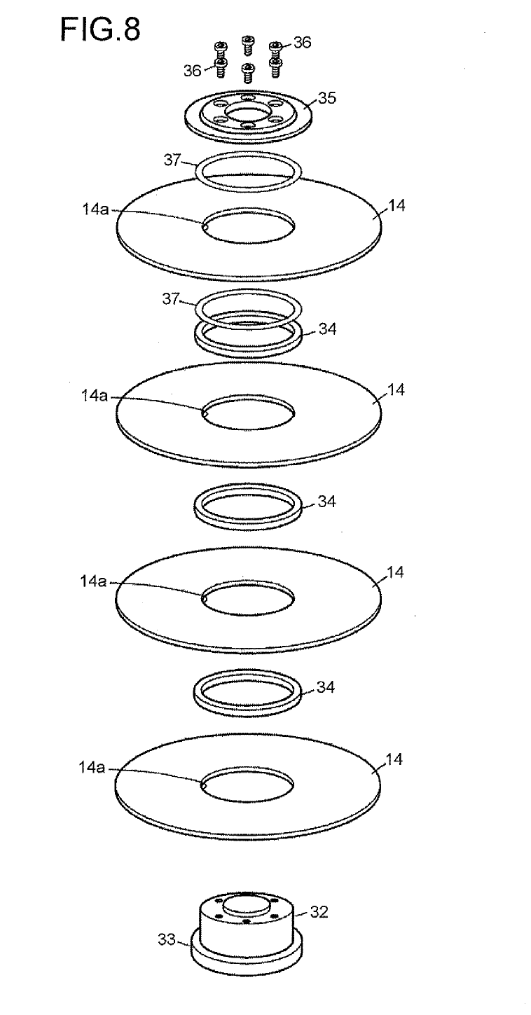

As illustrated in FIG. 8, the thin plate 37 may be arranged only on the face and back sides of the uppermost magnetic disk 14. The same configurations and structures as FIG. 3 are indicated by similar reference numerals. The spindle motor 15 can realize the same operation effect as FIG. 3. The number of the thin plates 37 is smaller than FIG. 3. The total thickness of the viscoelastic body 43 is reduced. The sag of the viscoelastic body 43 can be prevented. The relative error of the magnetic disk 14 and the carriage arm 19 can be reduced.

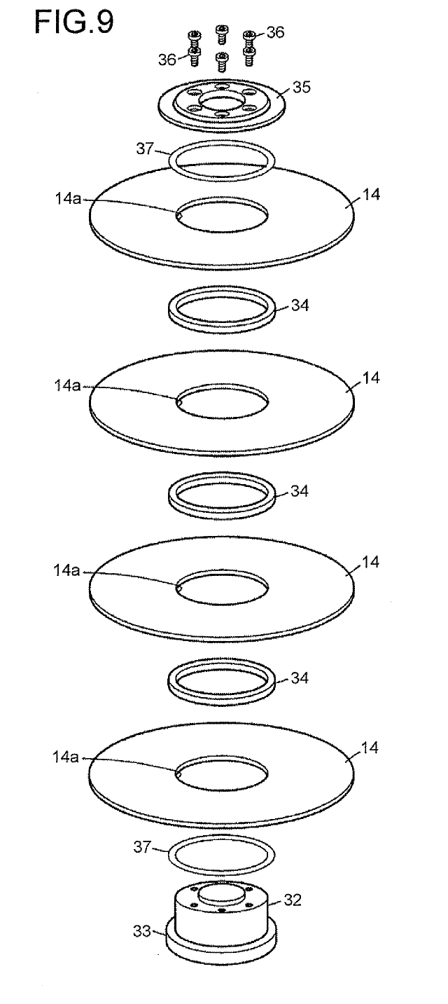

As illustrated in FIG. 9, the thin plate 37 may be arranged only on the surface of the uppermost magnetic disk 14 and the back of the lowermost magnetic disk 14. The same configurations and structures as FIG. 3 are indicated by similar reference numerals. The spindle motor 15 can realize the same operation effect as FIG. 3. The number of the thin plates 37 is smaller than FIG. 3. The total thickness of the viscoelastic body 43 is reduced. The sag of the viscoelastic body 43 can be prevented. The relative error of the magnetic disk 14 and the carriage arm 19 can be reduced.

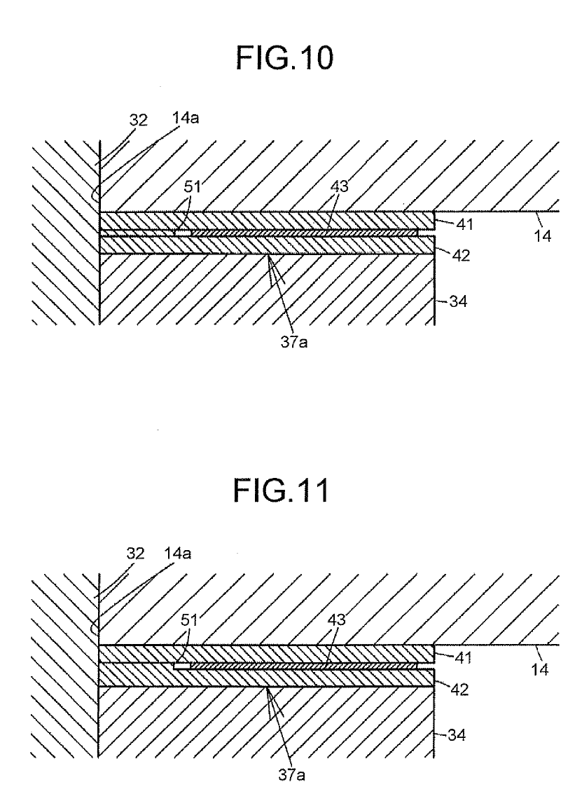

FIG. 10 schematically illustrates a configuration of a thin plate 37a according to another embodiment of the invention. The thin plate 37a has an auxiliary thin plate 51 interposed between the first thin plate 41 and the second thin plate 42 adjacent the inner edge of the thin plate 37a outside the viscoelastic body 43. The auxiliary thin plate 51 is interposed between the viscoelastic body 43 and the spindle hub 32. The auxiliary thin plate 51 may be formed of the same material as the first thin plate 41 and the second thin plate 42. The auxiliary thin plate 51 may have the same thickness as the viscoelastic body 43. The same configurations and structures as those of the thin plate 37 are indicated by similar reference numerals.

The thickness of the viscoelastic body 43 of the thin plate 37a may be set to about 50 μm. The thickness of the first thin plate 41 and the second thin plate 42 may be set to about 100 μm. In the thin plate 37a, the sag of the viscoelastic body 43 can be avoided by the action of the auxiliary thin plate 51. The thickness of the viscoelastic body 43 can be set to be large. The thickness of the viscoelastic body 43 may be set to about 100 μm and about 150 μm.

Since the auxiliary thin plate is not arranged adjacent to the outer edge of the thin plate 37a outside the viscoelastic body 43, the deformation of the viscoelastic body 43 can be allowed. The vibration of the magnetic disk 14 can be attenuated by the deformation of the viscoelastic body 43. The vibration attenuation effect can be increased by the increase in the thickness of the viscoelastic body 43. The thin plate 37a has a life longer than that of the thin plate 37. As illustrated in FIG. 11, the auxiliary thin plate 51 may be integrated with the second thin plate 42.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented byway of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recording medium drive comprising:
a stator;
a rotor configured to be rotatably supported by the stator;
recording disks configured to be mounted on the rotor;
an annular spacer configured to be mounted on the rotor between the recording disks; and
an annular thin plate configured to be mounted on the rotor between one of the recording disks and the annular spacer, wherein
the thin plate comprises
a first thin plate formed of a hard resin plate or a metal plate,
a second thin plate formed of a hard resin plate or a metal plate, the first thin plate configured to be adjacent to either the one of the recording disks or the annular spacer and the second thin plate configured to be adjacent to either the annular spacer or the one of recording disks, respectively, and
a viscoelastic body configured to be interposed between the first thin plate and the second thin plate.

2. The recording medium drive according to claim 1, wherein the first thin plate and the second thin plate are configured to extend in a radius direction of the recording disk more largely than the viscoelastic body.

3. The recording medium drive according to claim 2, wherein an inner edge of the viscoelastic body is configured to be arranged outside an inner edge of the first thin plate and an inner edge of the second thin plate in the radius direction of the recording disk.

4. The recording medium drive according to claim 2, further comprising an auxiliary thin plate configured to be interposed between the first thin plate and the second thin plate outside the viscoelastic body.

5. The recording medium drive according to claim 1, wherein the first thin plate and the second thin plate are formed of identical material.

6. The recording medium drive according to claim 1, wherein thickness of the first thin plate is configured to be equal to thickness of the second thin plate.

7. The recording medium drive according to claim 6, wherein thickness of the viscoelastic body is configured to be smaller than the thickness of the first thin plate.

8. A thin plate for a recording medium drive comprising:
a first annular thin plate;
a second annular thin plate comprising a surface facing a surface of the first thin plate, the first thin plate and the second thin plate being formed of identical material; and
a viscoelastic body configured to be interposed between the surface of the first thin plate and the surface of the second thin plate.

9. The thin plate for a recording medium drive according to claim 8, wherein the first thin plate and the second thin plate are configured to extend in a width direction more largely than the viscoelastic body.

10. The thin plate for a recording medium drive according to claim 9, wherein an inner edge of the viscoelastic body is configured to be arranged outside an inner edge of the first thin plate and an inner edge of the second thin plate.

11. The thin plate for a recording medium drive according to claim 9, further comprising an auxiliary thin plate configured to be interposed between the first thin plate and the second thin plate outside the viscoelastic body.

12. The thin plate for a recording medium drive according to claim 8, wherein the first thin plate and the second thin plate are formed of identical material.

13. The thin plate for a recording medium drive according to claim 8, wherein thickness of the first thin plate is configured to be equal to thickness of the second thin plate.

14. The thin plate for a recording medium drive according to claim 13, wherein thickness of the viscoelastic body is configured to be smaller than the thickness of the first thin plate.

15. A recording medium drive comprising:
a stator;
a rotor configured to be rotatably supported by the stator;
a recording disk configured to be mounted on the rotor;
a flange configured to be defined by the rotor;
a clamp configured to sandwich the recording disk with the flange; and
an annular thin plate configured to be mounted on the rotor between the recording disk and the flange, wherein
the thin plate comprises
a first thin plate configured to be adjacent to the magnetic disk,
a second thin plate configured to be adjacent to the flange, the first thin plate and the second thin plate being formed of identical material, and
a viscoelastic body configured to be interposed between the first thin plate and the second thin plate.

16. The recording medium drive according to claim 15, wherein the first thin plate and the second thin plate are configured to extend in a radius direction of the recording disk more largely than the viscoelastic body.

17. The recording medium drive according to claim 16, wherein an inner edge of the viscoelastic body is configured to be arranged outside an inner edge of the first thin plate and an inner edge of the second thin plate in the radius direction of the recording disk.

18. The recording medium drive according to claim 15, further comprising an auxiliary thin plate configured to be interposed between the first thin plate and the second thin plate outside the viscoelastic body.

19. The recording medium drive according to claim 15, wherein thickness of the first thin plate is configured to be equal to thickness of the second thin plate.

20. The recording medium drive according to claim 19, wherein thickness of the viscoelastic body is configured to be smaller than the thickness of the first thin plate.
